(19) United States
(12) Patent Application Publication
(10) Pub. No.: US 2011/0222433 A1
(43) Pub. Date: Sep. 15, 2011

(54) Automatic address configuration of vehicle network devices during installation

(76) Inventor: Gilbert Guy Jones, Clayton, NC (US)

(21) Appl. No.: 12/661,272

(22) Filed: Mar. 12, 2010

(51) Int. Cl. H04L 12/28

(52) U.S. Cl. 370/254

(57) ABSTRACT

A method for automatic network address configuration of network devices during installation is described. According to the method, a network address is configured on the devices and a check is performed as to whether the address is already in use. If not, a device is configured on the network. The method allows configuration of multiple identical devices with different network addresses.

### FIELD

The present disclosure is directed to network devices. In particular, it relates to methods for network address configuration and installation of vehicle network devices.

### BACKGROUND

Modern vehicles are becoming more and more dependent upon microprocessor (computerized) devices existing within the vehicle to perform functions desired in the vehicle. It is common for a vehicle to include several computerized devices. These devices can be, for example, engine controllers, radio controllers, modules controlling lighting and signaling, and so on.

Examples of additional computerized devices, also known in SAE (Society of Automotive Engineers) terms as ECUs, are: engine controller, transmission controller, brake system components (e.g., anti-lock controller, individual or vehicle wide controller for brake on axle), axle/suspension monitor, lighting controller (e.g., head lights, break lights, turn signals/emergency lights, in-cab lighting, etc), special controllers (e.g., cooling, refer, etc), GPS/navigation, passenger/fare accounting (on a passenger bus), farm implement controllers, and so on. Usually, these devices have the capability to transmit and receive over a network.

Most vehicles do not, however, contain multiple instances of the same device. For example, the vehicle usually only has one engine. Therefore, only one engine controller is needed and the engine controller is assigned a network address at the time of manufacture. In other words, the network address is either fixed or manually configured by some mechanism before the device is usable in the vehicle. For example, a mechanical switch or jumper/plug can be used. An example of such device is an “address plug”, i.e., an interconnect connector looping back on itself. In such device, if pins 1 and 6 are strapped together (via a jumper) then the address is # 1, whereas, if pins 2 and 5 are strapped together, it indicates address # 2. Another kind of device may include a dip switch on a circuit board, which is mechanically different but electrically identical to the address plug/jumper system. Other devices may have a hidden connector that allows connection to a computer (e.g., a laptop). Such method can be used when information that is addition to the ECU's network address (e.g., set point/governor system) has to be configured.

However, such manual configuration does not work properly if multiple independent devices are or may be present in the same vehicle, because there is a risk that these devices are configured with the same network address, thus making it impossible to distinguish between multiple instances of the same device.

### SUMMARY

According to a first aspect of the present disclosure, a method for automatic network address configuration of vehicle network devices during installation thereof is provided, comprising: selecting a vehicle network device of interest; checking whether a network address has already been configured on the selected vehicle network device; if a network address has not been configured on the selected vehicle network device, configuring the selected vehicle network device with a network address; checking whether the network address configured on the vehicle network device is already used by another vehicle network device; and, if the network address is not already used by another vehicle network device, adding the selected vehicle network device with the configured network address to the vehicle network.

According to a second aspect of the present disclosure, a method for automatic network address configuration of network devices during installation thereof is provided, comprising: selecting a network device of interest; checking whether a network address has already been configured on the selected network device; if a network address has not been configured on the selected network device, configuring the selected network device with a network address; checking whether the network address configured on the network device is already used by another network device; and, if the network address is not already used by another network device, adding the selected network device with the configured network address to the network.

The methods in accordance with the present disclosure eliminate the need for manual address configuration, thus easing installation and speed of installation, while eliminating the chance of error in configuring the device.

According to some of their embodiments, the methods of the present disclosure may primarily comprise a software technique and it may be applicable for most electronic communicating devices (not necessarily vehicle based systems), regardless of vendor or hardware platform. When used in a CAN network, in accordance with some embodiments of the disclosure, transacting of messages in accordance with the software technique will occur between a transmit register and a receiver register.

### BRIEF DESCRIPTION OF THE DRAWINGS

FIG. 1 shows a flow chart of an address configuration or assignment to a vehicle network device according to an embodiment of the present disclosure.

### DESCRIPTION

Throughout the present disclosure, a “vehicle network device” is defined as a controlling device on, associated to, or in a relationship with a vehicle, wherein the vehicle network device is capable of transmitting and/or receiving information via a network, and wherein the vehicle network device is capable of controlling one or more functions associated with the operation of a vehicle. By way of example, the vehicle network device can be any one of the ECUs mentioned in the background section of the application.

The vehicle network device according to the present disclosure can comprise an optional component of the vehicle and, when installed, can be one of many “identical” vehicle network devices on the same vehicle. By way of example, a vehicle could have multiple brake light controllers, one for the driver side and the other for the passenger side. Likewise, a trailer on a vehicle could also have similar system. In this case, there could be four different brake light controllers in the same vehicle, or a single controller in the trailer and two on the vehicle, etc. Another example could be a tractor equipped with a “hotel” or sleeper area. Such tractor can have multiple cab light systems and multiple air conditioners.

The present disclosure provides for a method of assigning different network addresses to different network devices, including different devices of the same type, such as two auxiliary power generators. Therefore, it is possible for a vehicle builder to install one or more of identical devices on a vehicle, and have the devices “self configure” themselves, thus assuring proper operation on the vehicle without any manual configuration activities whatsoever.

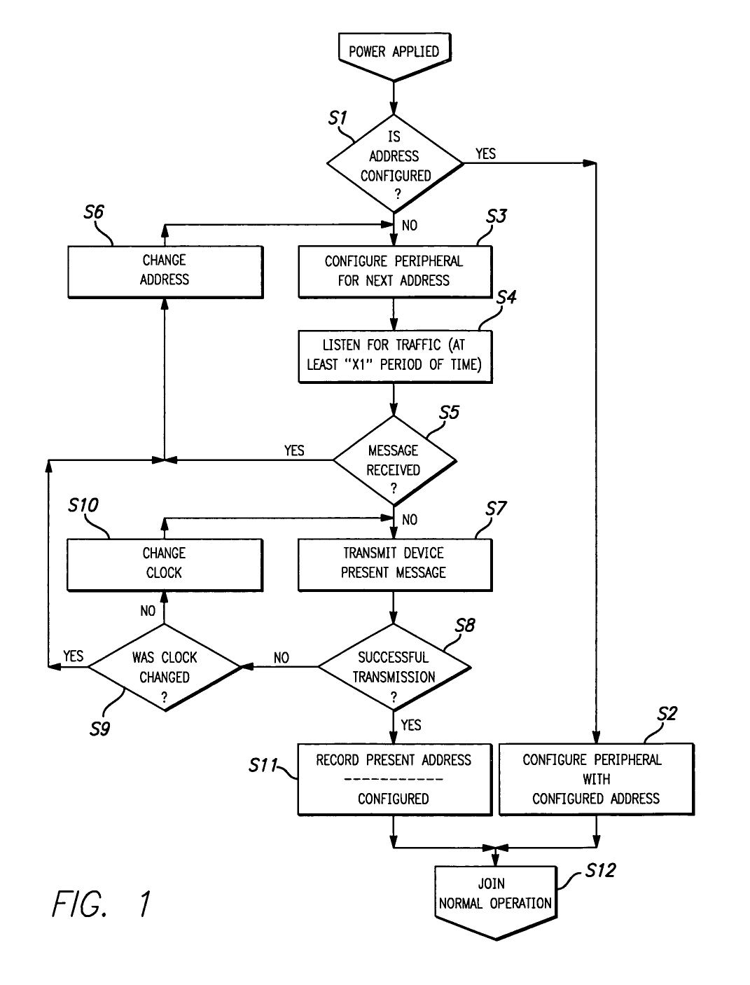

Reference is made to the flow chart of FIG. 1, where an example of address configuration or address assignment according to an embodiment of the present disclosure is shown. The aim of the address assignment procedure of FIG. 1 is that of providing a peripheral or device with a pre-assigned address before the peripheral or device joins the normal operation of the system. “Normal operation” is defined as a condition when the device is powered by the vehicle DC voltage, capable of communicating on a network, not in a diagnostic mode and not performing firmware download activities.

At a step S1, an initial verification is made to determine whether a network address has already been configured for a selected vehicle network device (peripheral). In particular, the vehicle network device can have a range of valid values that provide an expectation of what the network address of the device should be. For example, in the SAE J1939 standard (the vehicle bus standard used for communication and diagnostics among vehicle components), the address 255 is not a valid network address. By way of further example, assuming that the vehicle network device is an auxiliary power generator (APG), each APG can be expected to occupy only one of seven addresses (values 1 through 7). In such case, the implementation of an unconfigured address can be the value 0. In such case, if the memory location of the APG containing the address offset is not between 1 and 7, the address is not valid and should be configured.

If a network address has already been configured for the selected vehicle network device, the method proceeds to a step S2, whereat the selected device or peripheral is configured with the configured address. By way of example, the peripheral can do a reboot to set up the configured network address present in its network interface hardware.

Otherwise, the selected peripheral is configured with a next available address at a step S3. In the previous example of the APG device, configuration to the next address occurs by adding 1 to the address value.

After the selected peripheral is configured with the next address at the step S3, the method proceeds to a step S4 to determine whether the configured next address is already being used by another device or peripheral connected to the network. In order to make this determination, according to an embodiment of the present disclosure, at the step S4 the method according to the present disclosure listens for traffic on the network for a determined amount of time and attempts to receive a message from a device configured with this address. Configured non-passive devices usually send periodic messages either of their own accord or as a response to another device's message.

The amount of time that the method listens for traffic is determined in accordance with the longest periodic message transmission occurring on the network. In other words, the amount of time that the method listens for traffic at the step S4 is longer than the longest periodic transmission, in order to be able to listen to such periodic transmission if it occurs on the currently selected next address. According to an embodiment of the disclosure, the time period to wait for a message transmission is selected to be at least twice the time expected to see a message transmitted from the other device.

If such a message is received on the selected next address (at a step S5), then the selected next address is already assigned to another node and is therefore not available for use. As a consequence, a new address is selected at a step S6 and the method proceeds to the step S3. Alternatively, if no message is received at the step S5, the selected next address is available for use, and a message indicating that the device is present is transmitted by the device itself via the network at a step S7. In other words, in step S7 the device will start “talking” at the “captured” network address. Any device that needs to “listen” to the message of the new device can be selected to hear such message. In the above example of an APG on a vehicle network; possible listeners are the hybrid control module (HCM) and other APG devices attempting to automatically resolve an address as mentioned with reference to the previous step S4. The message sent by the new device can be any kind of periodic status message produced by a device on a network. A hybrid control module (HCM) is the primary controller/coordinator for action performed by components of a hybrid system, such as a motor/generator controller, clutch actuator, hydraulic pump and so on.

With reference to step S7, it should be noted that the periodic message transmitted can be a status message indicating a controller area network (CAN) network address “fault”/“warning.” In actual use, this transmitted message is not interpreted by the HCM (or any other vehicle component). Such message is diagnostic in nature and is not considered by the standard vehicle ECUs. However, when a diagnostic tool is also present in the configuration, it can distinguish this message and present the diagnostic information to a technician, thus informing the operator of the actions taking place. It should be noted that in accordance with several embodiments of the present disclosure, the very presence of the message—and not the message's content—is relevant. Therefore, the methods according to the present disclosure can be adjusted to function on other networks, even those that are not vehicle networks or vehicle CAN networks.

The method then proceeds to a step S8 to determine if the “device present” message was successfully transmitted over the network. If the transmission was not successful, the method proceeds to the step S6 whereat a new address is selected for the peripheral.

It should be noted that in a controller area network (CAN), usually every active device receives every message placed on the network. Assuming that two nodes transmit an identical message at the same instant, none of them can detect transmission of such message from the other node at that instant. However, if two nodes attempt to transmit the same message header and yet there is a difference in the data content portion of the message, an error is generated.

Therefore, in order to assure that two devices do not continue to transmit the same message causing the same error, according to an embodiment of the present disclosure, the clock of the device is changed at step S10, as soon as an unsuccessful outcome is generated at step S8. Step S7 is then repeated again. If, even after the change to the clock of the device (see also step S9), the transmission is not successful, the address of the device is changed (step S6) and the cycle S3-S4-S5-S7 is repeated, with the clock as changed. The amount by which the clock is changed can be a unique value. By way of example and not of limitation, such amount can be a function of the serial number of the device. This allows two “identical” devices to make a guaranteed different adjustment to each clock.

Otherwise, if the “device present” message transmission is successful, the method proceeds to a step S11 to record the selected address as the address of the selected peripheral. As soon as this occurs, the peripheral joins the network at a step S12 with its configured new address and performs its normal operating functions.

In the embodiment of a system comprised of an APG component and an HCM component, the HCM can control the supply of high voltage DC to the APG and confirm with the vehicle operator/driver the acceptability of providing the high voltage to the APG. In such embodiment, the driver can have a button in the cab that is depressed when the driver will allow the APG to operate. In such case, the HCM periodic message contains, for example, “enable” (ENA) signals that when received by the APG (in concomitance with a switch ON position) will start running the APG by providing AC voltage. The APG periodic message provides, operation and status information that the HCM can use to calculate how much battery life remains before it starts the engine and recharges the batteries. Fault/warning indications by the APG can be passed on to other processors inside the vehicle in order to alert the driver that a problem exists. Such indications may also be recorded to allow further analysis from a service center.

In accordance with one embodiment of the present disclosure shown in FIG. 1, existing network traffic is used to determine the absence or presence of a node (other vehicle network device) at a specific address. For example, as shown in FIG. 1, the method listens for network traffic at the step S4 in order to determine the absence or presence of a node at a specific address. It should also be noted that, in accordance with such embodiment, the node/device attempting to obtain an address from the described method does not transmit a message indicating its presence until the method proceeds to the step S7, i.e. until it is fairly certain that its address configuration attempt will be successful.

As already mentioned above, by way of example and not of limitation, a vehicle network device may comprise an auxiliary power generator (APG) adapted to be used, for example, with a hybrid vehicle system. The APG comprises an optional component of the vehicle and when installed may be one of many identical devices on the same vehicle. Because the APG is an optional component, not all vehicles will be assembled with an APG. Also, because there is a possibility of a vehicle assembler placing multiple APG devices on a single device, there is the need to account for multiple addresses.

Using the technique described above and shown in the flow chart of FIG. 1, a vehicle manufacturer can install one or more APGs on a vehicle, turn the vehicle power ON, and the devices will self configure themselves, thus assuring proper operation of the vehicle without need of any manual configuration activities whatsoever.

The person skilled in the art of network configuration will understand that the method of automatically configuring an address in accordance with the present disclosure does not depend upon any other device on the network to participate in the address selection. The only condition is for the other network devices to be active and behave normally.

Accordingly, what has been shown are systems and methods for automatic address configuration of vehicle network devices during installation. While the systems and methods have been described by means of specific embodiments and applications thereof, it is understood that numerous modifications and variations could be made thereto by those skilled in the art without departing from the spirit and scope of the disclosure. It is therefore to be understood that within the scope of the claims, the disclosure may be practiced otherwise than as specifically described herein.

1. A method for automatic network address configuration of vehicle network devices during installation thereof, comprising:
selecting a vehicle network device of interest;
checking whether a network address has already been configured on the selected vehicle network device;
if a network address has not been configured on the selected vehicle network device, configuring the selected vehicle network device with a network address;
checking whether the network address configured on the vehicle network device is already used by another vehicle network device; and,
if the network address is not already used by another vehicle network device, adding the selected vehicle network device with the configured network address to the vehicle network.

2. The method of claim 1, further comprising:
transmitting a message with the selected vehicle network device if the network address is not used by another vehicle network device, and configuring the network address on the selected network device if the message is successfully transmitted.

3. The method of claim 1, wherein checking whether a network address has already been configured on the selected vehicle network device comprises listening for presence of network traffic on the network address.

4. The method of claim 3, wherein presence of network traffic on the network address is listened to for an amount of time longer than the longest periodic message transmission on the network.

5. The method of claim 4, wherein the amount of time is more than twice the longest periodic message transmission on the network.

6. The method of claim 1, wherein configuring the selected vehicle with a network address comprises selecting the next available address on the network.

7. The method of claim 1, wherein configuring the network address on the selected vehicle network device comprises providing the network address to network interface hardware of the vehicle network device.

8. The method of claim 1, comprising configuring multiple identical vehicle network devices, each vehicle network device being configured with a different network address.

9. The method of claim 1, wherein confirmation of adding the selected vehicle network device with the configured network address to the vehicle network comprises generation of a network message by the selected vehicle network device with the configured network address.

10. The method of claim 1, further comprising
transmitting a message with the selected vehicle network device if the network address is not used by another vehicle network device, and changing the clock of the selected network device if the message is not successfully transmitted.

11. The method of claim 10, further comprising
transmitting the message again after changing the clock of the selected network device and, if the message is not successfully transmitted, configuring the selected network device with a new network address.

12. The method of claim 11, wherein configuring the selected network device with the new network address occurs after confirming that changing of the clock of the selected network device has occurred.

13. The method of claim 10, wherein the clock is changed by an amount that is unique to the selected network device.

14. The method of claim 13, wherein the amount is a function of a serial number of the selected network device.

15. The method of claim 1, wherein the automatic network address configuration occurs without participation of other vehicle network devices.

16. A method for automatic network address configuration of network devices during installation thereof, comprising:
selecting a network device of interest;
checking whether a network address has already been configured on the selected network device;
if a network address has not been configured on the selected network device, configuring the selected network device with a network address;
checking whether the network address configured on the network device is already used by another network device; and,
if the network address is not already used by another network device, adding the selected network device with the configured network address to the network.

17. The method of claim 16, wherein the automatic network address configuration occurs without participation of other network devices.
